(19) United States
(12) Patent Application Publication
(10) Pub. No.: US 2013/0183607 A1
(43) Pub. Date: Jul. 18, 2013

(54) METHANOL FUEL CELL CARTRIDGE

(71) Applicants: Toyo Seikan Kaisha, Ltd., Tokyo (JP); Kabushiki Kaisha Toshiba, Tokyo (JP)

(72) Inventors: Daisuke Imoda, Yokohama-shi (JP); Kyoko Yoshino, Yokohama-shi (JP); Yumiko Takizawa, Yokohama-shi (JP)

(73) Assignees: KABUSHIKI KAISHA TOSHIBA, Tokyo (JP); TOYO SEIKAN KAISHA, LTD., Tokyo (JP)

(21) Appl. No.: 13/669,381

(22) Filed: Nov. 5, 2012

Related U.S. Application Data
(62) Division of application No. 11/917,384, filed on Oct. 12, 2009, now abandoned.

(30) Foreign Application Priority Data
Jun. 17, 2005 (JP) 2005-177376

(51) Int. Cl. H01M 8/00

(52) U.S. Cl. CPC H01M 8/00
USPC 429/535

(57) ABSTRACT

The present invention provides a cartridge for a methanol fuel cell at low cost, which does not show deterioration in electric power generation performance, can be operated for a long period of time, and can be reduced in size and weight. In the present invention, the cartridge for a methanol fuel cell has art inner resin layer containing a resin having such a property that, after a film of the resin is immersed in methanol at 60° C. for 7 days, the methanol is diluted twice in terms of a volume ratio with distilled water at room temperature to give a liquid, the liquid shows a light transmittance of 10% or higher at 300 nm.

### CROSS-REFERENCES TO RELATED APPLICATIONS

This application is a division of U.S. patent application Ser. No. 11/917,384, filed Oct. 12, 2009, which is the National Stage of International Application No. PCT/JP2006/311787, filed Jun. 13, 2006, which claims priority to Japanese Application No. 2005-177376, filed Jun. 17, 2005, each of which is incorporated herein by reference in its entirety.

### TECHNICAL FIELD

The present invention relates to a portable cartridge for a methanol fuel cell suitably used as a fuel tank, a refill container, or the like for a direct methanol fuel cell (DMFC).

### BACKGROUND ART

A direct methanol fuel cell (DMFC) employing methanol as a fuel has attracted attention as a power source for a mobile device such as a laptop computer or a cell phone, and various types thereof are known (see Patent Documents 1 to 3, for example).

Patent Document 1: JP 2004-265872 A

Patent Document 2: JP 2004-259705 A

Patent Document 3: JP 2004-452741 A

For reduction in size of a cell in each of those fuel cells, reduction in size and weight of a fuel tank (cartridge) storing methanol as a fuel is required, and various cartridges are proposed (see Patent Documents 3 and 4, for example),

Patent Document 4: JP 2004-155450 A

However, when a cartridge storing methanol contains a resin material, there are disadvantages that low-molecular-weight organic compounds such as antioxidants, lubricants, etc. contained in the resin material are eluted in methanol as impurities; an electromotive voltage of a fuel cell is lowered; therefore continuous generation of power over a prolonged period of time is difficult.

In contrast, in order to prevent deterioration of the power generation performance of a fuel cell due to such impurities, there are proposed techniques in which a filter is provided; impurities contained in a fuel or oxidant gas supplied to a fuel cell are collected with an impurity collector containing a chelating agent; and the like (e.g., see Patent Document 5). When such a device is added to a fuel cell, there arise problems that reduction in size and weight of a fuel cell is difficult to achieve and the cost also increases.

Patent Document 5: JP 2004-227844 A

### DISCLOSURE OF THE INVENTION

### Problems to be Solved by the Invention

Therefore, the present invention aims to provide a cartridge for a methanol fuel cell, which allows continuous operation over a prolonged period of time without deteriorating power generation performance of a methanol fuel cell, and which attains reduction in size and weight, as well as a low cost.

### Means for Solving the Problems

In order to solve the above-mentioned problems, the present invention adopts the following structures of 1 to 7.

1. A cartridge for a methanol fuel cell, comprising: an inner resin layer containing a resin having such a property that, when a film of the resin is immersed in methanol at 60° C. for 7 days and then the methanol is diluted to twice with distilled water at room temperature to give a liquid, the liquid shows a light transmittance of 10% or higher at 300 nm.

2. A cartridge for a methanol fuel cell according to Item 1, in which the inner resin layer contains a resin selected from low-density polyethylene, linear low-density polyethylene, high-density polyethylene, polypropylene-based polymer, cyclic polyolefin copolymer, polyamide, fluorocarbon polymer, polyethylene terephthalate, and polyethylenenaphthalate.

3. A cartridge for a methanol fuel cell according to Item 2, in which a resin forming the inner resin layer contains a resin selected from high-density polyethylene polymerized by a Phillips method using a chrome oxide catalyst: or linear low-density polyethylene, high-density polyethylene, and a polypropylene-based polymer which are polymerized by a polymerization method using a metallocene catalyst.

4. A cartridge for a methanol fuel cell according to any one of Items 1 to 3, further comprising a methanol barrier layer containing a cyclic polyolefin copolymer.

5. A cartridge for a methanol fuel cell according to any one of Items 1 to 4, further comprising a main layer containing a polyolefin-based resin including a regenerated resin.

6. A cartridge for a methanol fuel cell according to any one of Items 1 to 5, further comprising a valve mechanism for preventing leakage at a pouring portion.

7. A cartridge for a methanol fuel cell according to any one of Items 1 to 6, in which the cartridge for a methanol fuel cell is installed in an outer case formed of a rigid material.

### Effect of the Invention

According to the present invention, the cartridge for a methanol fuel cell can be obtained at low cost, which allows continuous operation over a prolonged period of time without deterioration in the power generation performance of the methanol fuel cell. The cartridge for a methanol fuel cell of the present invention can achieve reduction in size and weight, and thus can be preferably used as a fuel tank or a refill container for DMFC.

### BEST MODE FOR CARRYING OUT THE INVENTION

### Light Transmittance

In the present invention, a cartridge for a methanol fuel cell has an inner resin layer containing a resin having such a property that when a film of the resin is immersed in methanol at 60° C. for 7 days, and then the methanol is diluted twice in terms of a volume ratio with distilled water at room temperature to give a liquid, the liquid shows a light transmittance of 10% or higher at 300 nm.

This light transmittance refers to a value of a liquid, measured at a wavelength of 300 nm using a spectrophotometer U-3310 manufactured by Hitachi High-Technologies Corporation. The liquid is obtained by immersing eight resin films measuring 15 mm in length, 40 mm in width, and 1 mm in thickness in 50 mL of methanol (for precise analysis: 99.8% methanol content) manufactured by Wako Pure Chemical Industries Ltd., at 60° C. for 7 clays, and then diluting the methanol twice in terms of a volume ratio with distilled water at room temperature.

There is no limitation on the resin forming the inner resin layer of the cartridge for a methanol fuel cell of the present invention insofar as it has the light transmittance described above. It is preferable to use a resin selected from low-density polyethylene, linear low-density polyethylene, high-density polyethylene, polypropylene-based polymer, cyclic polyolefin copolymer, polyamide, fluorocarbon polymer, polyethylene terephthalate, and polyethylenenaphthalate. Those resins can be used alone or in combination of two or more.

Mentioned as particularly preferable resins are high-density polyethylenes polymerized by the Phillips method using a chrome oxide catalyst; or linear low-density polyethylenes, high-density polyethylenes, and the polypropylene-based polymers which are polymerized by a polymerization method using a metallocene catalyst.

There is no limitation on the layer structure of the cartridge for a methanol fuel cell of the present invention insofar as the resin layer described above is provided on the inner layer of the cartridge. For example, a cartridge having a monolayer structure containing a resin serving as an inner resin layer can be obtained. Moreover, a cartridge having a multilayer structure containing at least one resin layer or a layer formed of another material on the outside of the above-described inner resin layer can be obtained.

In the case of a cartridge having a multilayer structure, it is preferable to have a methanol barrier layer, particularly a methanol barrier layer whose methanol vapor transmittance coefficient is 15 μg·mm/m²· hr or lower at 40° C., and a main layer containing polyolefin-based resin including a regenerated resin containing fins, a defective, etc., which are generated when the cartridge is manufactured.

Examples of a material used for forming such a methanol barrier layer include a cyclic olefin-based resin and a polyester-based resin. Those resins may be used unoriented, or may arbitrarily be uniaxially oriented or biaxially oriented.

A cyclic olefin-based polymer (COP) or a copolymer of ethylene and a cyclic olefin (COC: cycloolefin copolymer), known as a material used for forming a bottle, can be used as the cyclic olefin-based resin. COC includes a copolymer substantially and entirely formed of COC and a copolymer blended with other polyolefins.

A non-crystalline or low-crystalline copolymer produced from 10 to 50 mol %, in particular, 15 to 48 mol % of a cyclic olefin and the balance of ethylene and having a glass transition point of 5 to 200° C., in particular, 40 to 190° C. is preferably used as COC. Further, a copolymer obtained by substituting a part of ethylene forming a copolymer with a cyclic olefin for another α-olefin having about 3 to 20 carbon atoms, such as propylene, 1-butene, 1-pentene, 1-hexene, 1-octene, 3-methyl-1-pentene, or 1-decene, may be used.

An alicyclic hydrocarbon compound having an ethylenic unsaturated bond and a bicycle ring is preferred as the cyclic olefin. Specific examples of the cyclic olefin forming a repeating unit with a norbornane structure include; 8-ethyl-tetracyclo[4,4.0.1.2,5.12,5,17,10]-dodeca-3-ene; 8-ethylidene-tetracyclo[4.4.0.1.2,5.17,10]-dodeca-3-ene; and 8-methyl-tetracyclo[4.4.0.1.2,5.17,10]-dodeca-3-ene. Examples of a cyclic olefin forming a repeating unit without norbornane structure include: 5-ethylidene-bicyclo[2,2,1]hepto-2-ene; 5-ethyl-bicyclo[2,2,1]hepto-2-ene; and tetracyclo[7.4.0.02,7.110,13]-trideca-2,4,6,11-tetraene.

Examples of the polyester resin to be used include: a polyester homopolymer and a polyester copolymer such as polyethylene terephthalate (PET), polybutylene terephthalate (PBT), and polyethylene naphthalate (PEN) The polyester homopolymer and the polyester copolymer are each obtained through a reaction of: a dicarboxylic acid component such as terephthalic acid, isophthalic acid, p-β-oxyethoxybenzoic acid, naphthalene 2,6-dicarboxylic acid, diphenoxyethane-4,4′-dicarboxylic acid, 5-sodium sulfoisophthalic acid, adipic acid, sebacic acid, or an alkyl ester derivative thereof, or a polyvalent carboxylic acid component such as trimellitic acid: and a glycol component such as ethylene glycol, propylene glycol, 1,4-butanediol, neopentyl glycol, 1,6-hexylene glycol, cyclohexane dimethanol, an ethylene oxide adduct of bisphenol A, diethylene glycol, or triethylene glycol. Further, a homopolymer or a copolymer such as polylactic acid which is obtained through a reaction of a hydroxycarboxylic acid may also be used. One kind of polyester may be used alone, or two or more kinds thereof may be blended and used.

Another example of the polyester resin is a high-density polyester resin such as polyglycolic acid resin or the like having a density of 1.5 or more.

The polyglycolic acid is a polymer of a hydroxyacetic acid, and is a polyester having one carbon atom in an ester bond as described in U.S. Pat. No. 2,676,945, for example. The polyglycolic acid has a compact crystalline structure compared with that of a normal thermoplastic polyester, thus has a high-density, and exhibits lower water vapor permeability than those of other polyesters. Not only a homopolymer of the polyglycolic acid but also a copolymer having a part of glycolic acid substituted for another copolymer component may be used.

Resins each having an inorganic coating film may be used as another material used for forming the methanol impermeable layer. Examples of the inorganic coating film include: various carbon coating films such as a diamond-like carbon coating film and a modified carbon coating film; a titanium oxide coating film; a silicon oxide (silica) coating film; an aluminum oxide (alumina) coating film; a ceramics coating film; a silicon carbide coating film; and a silicon nitride coating film. Resins having those coating films are not particularly limited, and any one of thermoplastic resins to be generally used for producing plastic containers may be used.

Examples of a preferable resin having the inorganic coating film include a silica vapor deposited polyester film, an alumina vapor deposited polyester film, a silica vapor deposited nylon film, an alumina vapor deposited nylon film, an alumina vapor deposited polypropylene film, a carbon film vapor deposited polyester film, and a carbon film vapor deposited nylon film. Further, the examples thereof include a co-vapor deposited film prepared through co-vapor deposition of alumina and silica on a base film such as a polyester film or a nylon film. However, the resin is not limited to the examples described above.

A resin layer having an inorganic coating film formed on a film-like or sheet-like resin surface in advance through chemical vapor deposition, plasma vapor deposition, sputtering, or the like may be used as a resin layer having an inorganic coating film.

In the case where the cartridge for a methanol fuel cell of the present invention has a multilayer structure, resins each formed of a thermoplastic resin having or not having heat sealing property may be used as a material used for forming an intermediate layer, an outer layer, or the like of the container.

Examples of such a thermoplastic resin include: polyolefins such as crystalline polypropylene, a crystalline propylene/ethylene copolymer, crystalline polybutene-1, crystalline poly4-methylpentene-1, low-, medium-, or high-density polyethylene, an ethylene/vinyl acetate copolymer (EVA), a saponified EVA, an ethylene/ethyl acrylate copolymer (EEA), and an ion crosslinked olefin copolymer (ionomer); an aromatic vinyl copolymer such as polystyrene or a styrene/butadiene copolymer; a halogenated vinyl polymer such as polyvinyl chloride or a vinylidene chloride resin; a polyacrylic resin; a nitrile polymer such as an acrylonitrile/styrene copolymer or an acrylonitrile/styrene/butadiene copolymer; polyesters such as polyethylene terephthalate and polytetramethylene terephthalate; various polycarbonates; fluorocarbon polymer; and polyacetals such as polyoxymethylene. Those thermoplastic resins may be used alone or in combination of two or more. Further, those thermoplastic resins may be used by mixing various additives.

An adhesive resin is disposed between layers of the container having a multilayer structure as required. Such an adhesive resin is not particularly limited, and any one of a polyurethane-based resin, an acid-modified ethylene/α-olefin copolymer, a vinyl acetate-based resin, and the like generally used for production of a plastic container may be used.

A resin obtained through graft modification of an ethylene/α-olefin copolymer prepared through copolymerization of ethylene and an α-olefin having 10 or less carbon atoms such as propylene, 1-butene, 1-pentene, 1-heptene, or 1-octene with an unsaturated carboxylic acid such as acrylic acid, methacrylic acid, maleic acid, fumaric acid, itaconic acid, or crotonic acid or an anhydride thereof is preferably used as the acid-modified ethylene/α-olefin copolymer. A graft modification rate of the adhesive resin is preferably about 0.05 to 5 wt %. Those acid-modified ethylene/α-olefin copolymers may be used alone or in combination of two or more. Further, an ethylene/α-olefin copolymer modified in advance with an acid in high concentrations, and a polyolefin-based resin such as unmodified low-density polyethylene, an ethylene/vinyl acetate copolymer, an ethylene/α-olefin copolymer, or high-density polyethylene may be mixed, and the thus-obtained blended product adjusted to have an acid modification rate of about 0.05 to 5 wt % as a whole resin may be used as an adhesive resin.

The resin layer used for forming the cartridge for a methanol fuel cell of the present invention may contain an additive such as a lubricant formed of a higher fatty amide such as amide oleate, amide stearate, amide erucate, or amide behenate; a crystalline nucleating agent generally added to a plastic container; a UV absorber; an antistatic agent; a colorant such as a pigment; an antioxidant; or a neutralizer.

A shape of the cartridge for a methanol fuel cell of the present invention is not limited, and the cartridge may have various shapes including a hollow container such as a bottle, a cartridge, or a cup; a flat pouch; and a standing pouch.

As a method of producing a container, a general method may be employed. For example, the hollow container such as a bottle, a cartridge, or a cup may be produced by a method including Injection molding, blow molding such as direct blow or biaxial i orientation blow molding, or vacuum/pressure forming, but biaxial orientation blow molding is preferably employed. The pouches such as a flat pouch and a standing pouch can be produced by heat sealing a multilayer film having a heat sealing resin layer as an innermost layer. Those containers are each preferably provided with means for forming a pouring portion such as a screw cap or a spout. Further, the pouring portion of the cartridge for a methanol fuel cell is particularly preferably provided with a valve mechanism for preventing leakage.

Dimensions of the cartridge for a methanol fuel cell of the present invention are not particularly limited. In the case where the cartridge is used for a fuel tank or a refill container for DMFC to be used as a power source for a laptop computer, a cell phone, or the like, a content volume is preferably 1 to 500 ml, and particularly preferably about 10 to 200 ml.

The cartridge for a methanol fuel cell of the present invention can he produced as a container having a monolayer or multilayer structure. The obtained container may be installed in an outer case formed of a rigid material such as metal or fiber reinforced plastic.

In the case where the container has a multilayer structure, preferred examples of the layer structure include in the order given from an inner layer of the container: high-density polyethylene (HDPE)/adhesive resin (Ad)/cyclic polyolefin copolymer (COC)/Ad/HDPE; HDPE/HDPE+regenerated resin (Reg)/Ad/COC/Ad/HDPE; low-density polyethlene (LDPE)/Ad/COC/Ad/HDPE; LDPE/HDPE+Reg/Ad/COC/Ad/HDPE; LDPE/Ad/COC/Ad/polypropylene (PP); LDPE/Ad/COC/Ad/PP+Reg/PP; metallocene catalyst polymerized linear low-density polyethylene (m-LLDPE)/Ad/COC/Ad/PP; m-LLDPE/Ad/COC/Ad/PP+Reg/PP; HDPE/Ad/COC/Ad/HDPE+Reg/HDPE; HDPE/Ad/COC/Ad/PP; HDPE/PP+Reg/Ad/COC/Ad/PP; HDPE/Ad/COC/Ad/PP+Reg/PP; HDPE+m-LLDPE/Ad/COC/Ad/HDPE+m-LLDPE; HDPE+m-LLDPE/HDPE+Reg/Ad/COC/Ad/HDPE+m-LLDPE; HDPE+m-LLDPE/Ad/COC/Ad/HDPE+Reg/HDPE+m-LLDPE; HDPE+m-LLDPE/Ad/COC/Ad/PP; HDPE+m-LLDPE/PP+Reg/Ad/COC/Ad/PP; and HDPE+m-LLDPE/Ad/COC/Ad/PP+Reg/PP, (Herein, “A+B” refers to a resin containing a resin A and a resin B.)

### EXAMPLES

Hereinafter, the present invention will be described in more detail by way of examples, but the present invention is not limited to the following specific examples. In the following examples, the light transmittance of a resin film and the power generation performance of a methanol fuel cell were measured as follows.

(Light Transmittance)

Eight resin films measuring 15 mm in length, 40 mm in width, and 1 mm in

thickness were immersed in 50 ml of methanol (for precise analysis: 99.8% methanol content) manufactured by Wako Pure Chemical Industries Ltd., at 60° C. for 7 days, and then the methanol was diluted twice in terms of a volume ratio with distilled water at room temperature, thereby obtaining a sample liquid. The light transmittance of the sample liquid was measured at a wavelength of 300 nm using a spectrophotometer U-3310 manufactured by Hitachi High-Technologies Corporation.

(Power Generation Performance)

A fuel cell cartridge was charged with 50 ml, of methanol (for precise analysis: 99.8% methanol content) manufactured by Wako Pure Chemical Industries Ltd., sealed with a cap equipped with a packing made of tetrafluoroethylene, and stored at 60° C. for 168 hours. While using the stored methanol as fuel, the time required for the electromotive voltage to fail by 20% relative to the initial electromotive voltage at the time of power generation was measured using a micro fuel cell tester. When the time was 100 hours or less, it was judged to be “×”; when the time was more than 100 hours and up to 500 hours, it was judged to be “∘”, and when the time over 500 hours, it was judged to be “⊚”,

### Example 1

As a resin forming a container, an LDPE (additive free) having a light transmittance of 93%, an MFR at 190° C. of 0.5 g /10 min, and a density of 0.929 g/cm³ was used. A parison obtained through extrusion of this resin by a conventional method was subjected to direct blow molding with a rotary blow molding machine, to thereby produce an LDPE monolayer bottle-shaped fuel cell cartridge having a thickness of 500 μm, a full content volume of 60 mL, and a mass of 10 g.

### Example 2

The same fuel cell cartridge having a monolayer structure containing a m-LLDPE was produced following the procedure of Example 1 except using, as a resin forming a container, the m-LLDPE (additive free) having a light transmittance of 87%, an MFR at 190° C. of 0.9 g/10 min, and a density of 0.908 g/cm³.

### Example 3

The same fuel cell cartridge having a monolayer structure containing a z-HDPE was produced following the procedure of Example 1 except using, as a resin forming a container, a high-density polyethylene (z-HDPE: containing, as additives, 150 ppm of Irganox 1010, 200 ppm of Irgafos 168, 2000 ppm of Armoslip 310, and 1000 ppm of calcium stearate) polymerized using a Ziegler catalyst having a light transmittance of 26%, an MFR at 190° C. of 0,25 g/10 min, and a density of 0.951 g/cm³.

### Example 4

The same fuel cell cartridge having a monolayer structure containing a p-HDPE was produced following the procedure of Example 1 except using, as a resin forming a container, a high-density polyethylene (p-HDPE: additive tree) polymerized using a Phillips catalyst having a light transmittance of 94%, an MFR at 190° C. of 0.3 g/10 min, and a density of 0.946 g/cm³.

### Example 5

The same fuel cell cartridge having a monolayer structure containing a m-HDPE was produced following the procedure of Example 1 except using, as a resin forming a container, a high-density polyethylene (m-HDPE: additive free) polymerized using a metallocene catalyst having a light transmittance of 97%, an MFR at 190° C. of 0.35 g/10 min, and a density of 0.959 g/cm³.

### Example 6

The same fuel cell cartridge having a monolayer structure containing a z-random PP was produced following the procedure of Example 1 except using, as a resin forming a container, a propylene random copolymer (z-random PP: containing, as additives, 2000ppm of Irganox 1010, 1000 ppm of amide erucate, 1000 ppm of calcium stearate, and 1000 ppm of hydrotalsite) polymerized using a Ziegler catalyst having a light transmittance of 10%, an MFR at 230° C. of 1.7 g/10 min, and a density of 0.9 g/cm³.

### Example 7

The same fuel cell cartridge having a monolayer structure containing a m-random PP was produced following the procedure of Example 1 except using, as a resin forming a container, a propylene random copolymer (m-random PP: containing, as an additive, 200 ppm of Irganox 1010) polymerized using a metallocene catalyst having a light transmittance of 82%, an MFR at 230° C. of 2.0 g/10 min, and a density of 0.9 g/cm³.

### Example 8

The same fuel cell cartridge having a monolayer structure containing a nylon 6/66copolymer was produced following the procedure of Example 1 except using, as a resin forming a container, a nylon 6/66 copolymer (nylon 66 content of 15 mol %: containing, as an additive, 300 ppm of calcium stearate) having a light transmittance of 83%, a relative viscosity (96% H₂SO₄ solution) of 4.05, and a melting point of 196° C.

### Example 9

The same fuel cell cartridge having a monolayer structure containing a fluororesin was produced following the procedure of Example 1 except using, as a resin forming a container, a fluororesin (tetrafluoroethylene perfluoroalkyl vinyl-ether copolymer: additive free) having a light transmittance of 99%, an MFR at 372° C. under a load of 5kgf of 2 g/10 min, and a melting point of 305° C.

### Comparative Example 1

The same fuel cell cartridge having a monolayer structure containing a z-LLHDPE was produced following the procedure of Example 1 except using, as a resin forming a container, a linear low-density polyethylene (z-LLDPE: containing, as additives, 330 ppm of Irganox 1010, 670 ppm of Irgafos 168) polymerized using a Ziegler catalyst having a light transmittance of 8%, an MFR at 390° C. of 0.75 g/10 min, and a density of 0.922 g/cm³.

### Comparative Example 2

The same fuel cell cartridge having a monolayer structure containing a z-block PP was produced following the procedure of Example I except using, as a resin forming a container, a propylene block copolymer (z-block PP: containing, as additives, 5400 ppm of Irganox 1010, 1000 ppm of Irgafos 168, 2300 ppm of Electrostripper EA, 540 ppm of Tinuvin 326, and 1600 ppm of calcium stearate) polymerized using a Ziegler catalyst having a light transmittance of 5% , an MFR at 230° C. of 1.1 g/10 min, and a density of 0.9 g/cm³.

Each of the fuel cell cartridges obtained in Examples 1 to 9 and Comparative Examples 1 and 2 described above was subjected to a power generation performance test, and the results are shown in Table 1.

TABLE 1

| | Power generation performance test | |
|---|---|---|
| | | Time required for electromotive |
| | Judgment | voltage to fall by 20% (hr) |
| Example 1 | ⊚ | >500 |
| Example 2 | ◯ | 450 |
| Example 3 | ◯ | 290 |
| Example 4 | ⊚ | >500 |
| Example 5 | ⊚ | >500 |
| Example 6 | ◯ | 110 |
| Example 7 | ◯ | 420 |
| Example 8 | ◯ | 440 |
| Example 9 | ⊚ | >500 |
| Comparative Example 1 | X | 25 |
| Comparative Example 2 | X | 9 |

In the following Examples, a resin, which was difficult to subject to a direct blow molding when it had a monolayer structure due to the low melt tension, was used as an inner layer, and a parison was produced through co-extrusion by a conventional method by using multiple multilayer dies. The obtained parison was subjected to direct blow molding with a rotary blow molding machine, to thereby produce a bottle-shaped fuel cell cartridge having a three-layer structure of two different resin layers (total thickness: 550 μm).

### Example 10

Using as a resin forming an inner layer of a cartridge, an ethylene/tetracyclo dodecene copolymer of COC (ethylene content of 82 mol %: containing, as an additive, 3000 ppm of calcium stearate) having a light transmittance of 93% and an MFR at 260° C. of 15 g/10 min; using, as an adhesive resin, maleic anhydride-modified polypropylene having 60 meq/100 g of carbonyl groups; and using, as a resin forming an outer layer, the z-block PP used in Comparative Example 2, a parison was produced through co-extrusion by a conventional method. The obtained parison was subjected to direct blow molding with a rotary blow molding machine, to thereby produce a fuel cell cartridge having a three-layer structure of two different resin layers of COC (thickness: 150 μm)/Ad (thickness: 20 μm)/z-block PP (thickness: 330 μm) in the order given from an inner layer and having a full content volume of 60 mL and a mass of 10 g.

### Comparative Example 3

By following the procedure of Example 10 except using, as a resin forming an inner layer, an amorphous polyethylene terephthalate copolymer (PETG: additive free) having a light transmittance of 7%, an intrinsic viscosity (IV) of 0,75 dl/g, and a density of 1.27 g/cm³, a fuel cell cartridge having a three-layer structure of two different resin layers of PETG (thickness: 150 μm)/Ad (thickness: 20 μm)/z-block PP (thickness: 330 μm) in the order given from an inner layer and having a full content volume of 60 mL and a mass of 10 g was produced.

Each of the fuel cell cartridges obtained in Example 10 and Comparative Example 3 described above was subjected to a power generation performance test, and the results are shown in Table 2.

TABLE 2

| | Power generation performance test | |
|---|---|---|
| | | Time required for electromotive |
| | Judgment | voltage to fall by 20% (hr) |
| Example 10 | ◯ | 390 |
| Comparative Example 3 | X | 13 |

In the following examples, a preform was obtained from a polyester resin through injection molding. This preform was subjected to biaxial orientation blow molding at 2.6 times in a longitudinal direction and 2.2 times in a lateral direction with a biaxial orientation blow molding machine (Nissei ASB-50H, manufactured by NISSEI ASB MACHINE CO., LTD.), to thereby produce a monolayer bottle-shaped fuel cell cartridge.

### Example 11

Used as a polyester resin forming a preform was polyethylene terephthalate (PET: additive free), which was polymerized using a germanium catalyst, having a light transmittance of 91%, an intrinsic viscosity (IV) of 0.75 dl/g, a density of 1.40 g/cm³, and a melting point of 252° C. The obtained preform was subjected to biaxial orientation blow molding, to thereby produce a monolayer fuel cell cartridge having a full content volume of 60 mL, a mass of 10 g, and an average thickness of 0.45 mm.

### Example 12

By following the procedure of Example 11 except using, as a polyester resin, polyethylene naphthalate (PEN: additive free), which was polymerized using an antimony catalyst, having a light transmittance of 94%, an intrinsic viscosity (IV) of 0.70 dl/g, a density of 1.33 g/cm³, and a melting point of 265° C., a monolayer fuel cell cartridge having a full content volume of 60 mL, a mass of 10 g, and an average thickness of 0.45 mm was produced.

### Example 13

By following the procedure of Example 11 except using, as a polyester resin, a resin in which the PET used in Example 11 and the PEN used in Example 12 were blended in such a manner as to have a PET content of 30 wt %, a monolayer fuel cell cartridge having a full content, volume of 60 ml, a mass of 10 g, and an average thickness of 0.45 mm was produced.

Each of the fuel cell cartridges obtained in Examples 11 to 13 was subjected to a power generation performance test, and the results are shown in Table 3.

TABLE 3

Power generation performance test

| | | Time required for electromotive |
|---|---|---|
| | Judgment | voltage to fall by 20% (hr) |
| Example 11 | ◯ | 310 |
| Example 12 | ◯ | 370 |
| Example 13 | ◯ | 340 |

In the following examples, a parison was produced through co-extrusion by a conventional method by using multiple multilayer dies using a COC having a methanol barrier property in any one of layers of the multilayer cartridge. The obtained parison was subjected to direct blow molding with a rotary blow molding machine, to thereby produce a multilayer bottle-shaped fuel cell cartridge having a total thickness of 500 μm.

### Example 14

Using the p-HDPE used in Example 4 as a resin forming the innermost layer and the outermost layer; using the same p-HDPE containing a regenerated resin as a resin forming a main layer; using the COC used in Example 10 as a resin forming an i intermediate layer; and using the adhesive resin used in Example 10 as an adhesive resin layer, a parison was produced through co-extrusion by a conventional method. The obtained parison was subjected to direct blow molding with a rotary blow molding machine, to thereby produce a multilayer fuel cell cartridge having a six-layer structure of four different resin layers of p-HDPE (thickness: 100 μm)/Ad (thickness: 20 μm)/COC (thickness: 150 μm)/Ad (thickness: 20 μm)/p-HDPE+Reg (thickness: 135 μm)/p-HDPE (thickness: 75 μm) in the order given from an inner layer and having a full content volume of 60 mL and a mass of 10 g.

### Example 15

By following the procedure of Example 14 except using the LDPE used in Example 1 as a resin forming the innermost layer; using the z-block PP used in Comparative Example 2 as a resin forming the outermost layer; and using a z-block PP containing a regenerated resin as a resin forming a main layer, a multilayer fuel cell cartridge having a six-layer structure of five different resin layers of LDPE (thickness: 100 _82 m)/Ad (thickness: 20 μm)/COC (thickness: 150 μm)/Ad (thickness: 20 μm)/z-block PP+Reg (thickness: 135 μm)/ z-block PP (thickness: 75 μm) in the order given from an inner layer and having a full content volume of 60 mL and a mass of 10 g was produced.

### Example 16

By following the procedure of Example 15 except using the m-LLDPE used in Example 2 as a resin forming the innermost layer, a multilayer fuel cell cartridge having a six-layer structure of five different resin layers of m-LLDPE (thickness: 100 μm)/Ad (thickness; 20 μm)/COC (thickness: 150 μm)/Ad (thickness: 20 μm)/z-block PP+Reg (thickness: 135 μm)/z-block PP (thickness: 75 μm) in the order given from an inner layer and having a full content volume of 60 mL and a mass of 10 g was produced.

### Example 17

By following the procedure of Example 15 except using as a resin forming the innermost layer a resin in which 70 wt % of the p-HDPE used in Examples 4 and 30 wt % of the m-LLDPE used in Example 2 were blended, a multilayer fuel ceil cartridge having a six-layer structure of five different resin layers of p-HDPE (70 wt %) +m-LLDPE (30 wt %) (thickness: 100 μm)/Ad (thickness: 20 μm) COC (thickness: 150 μm)/Ad (thickness: 20 μm)/z-block PP+Reg (thickness: 135 μm)/z-block PP (thickness: 75 μm) in the order given from an inner layer and having a full content volume of 60 mL and a mass of 10 g was produced.

Each of the fuel cell cartridges obtained in Examples 14 to 17 and Examples 1 to 3 and 10 described above was subjected to a power generation performance test and the following methanol reduction test, and the results are shown in Table 4.

(Methanol Reduction Test)

A fuel cell cartridge was charged with 50 mL of methanol (for precise analysis: 99.8% methanol content) manufactured by Wako Pure Chemical Industries Ltd., sealed with a cap equipped with a packing made of tetrafluoroethylene, and stored at 40° C. for 24 hours. Then, the weight of the fuel cell cartridge was measured, and the measured weight was defined as an initial weight (W₀).

After the initial weight was measured, the weight (W₁) of the cartridge that was further stored at 40° C. for 14 days was measured, thereby obtaining a reduction value (W₀−W₁). Thus, the methanol reduction amount per day was calculated.

TABLE 4

| | Power generation performance test | | |
|---|---|---|---|
| | | Time required for | Methanol reduction |
| | | electromotive voltage to | degree |
| | Judgment | fall by 20% (hr) | (mg/day) |
| Example 1 | ⊚ | >500 | 0.6 |
| Example 2 | ◯ | 450 | 35.7 |
| Example 3 | ◯ | 290 | 11.6 |
| Example 10 | ◯ | 390 | 5.0 |
| Example 14 | ⊚ | >500 | 3.9 |
| Example 15 | ⊚ | >500 | 6.7 |
| Example 16 | ◯ | 340 | 5.9 |
| Example 17 | ⊚ | >500 | 4.5 |

1. A method for manufacturing a cartridge for a methanol fuel cell, comprising providing an inner resin layer comprising a resin having such a property that, when a film of the resin is immersed in methanol at 60° C. for 7 days and then the methanol is diluted to twice with distilled water at room temperature to give a liquid, the liquid shows a light transmittance of 10% or higher at 300 nm.

2. A method for manufacturing a cartridge for a methanol fuel cell according to claim 1, wherein the inner resin layer comprises a resin selected from low-density polyethylene, linear low-density polyethylene, high-density polyethylene, polypropylene-based polymer, cyclic polyolefin copolymer, polyamide, fluorocarbon polymer, polyethylene terephthalate, and polyethylenenaphthalate.

3. A method for manufacturing a cartridge for a methanol fuel cell according to claim 1, wherein the resin forming the inner resin layer comprises a resin selected from the group consisting of high-density polyethylene polymerized by a Phillips method using a chrome oxide catalyst, linear low-density polyethylene polymerized by a metallocene catalyst, and high-density polyethylene polymerized by a metallocene catalyst.

4. A method for manufacturing a cartridge for a methanol fuel cell according to claim 1, further comprising forming a methanol barrier layer surrounding the inner resin layer and comprising a cyclic polyolefin copolymer.

5. A method for manufacturing a cartridge for a methanol fuel cell according to claim 1, further comprising forming a main layer surrounding the inner resin layer and comprising a polyolefin-based resin including a regenerated resin.

6. A method for manufacturing a cartridge for a methanol fuel cell according to claim 1, further comprising forming a valve mechanism through at least the inner resin layer and configured to prevent leakage at a pouring portion.

7. A method for manufacturing a cartridge for a methanol fuel cell according to claim 1, further comprising forming an outer case as the outermost layer of the cartridge and formed of a rigid material.
